(19) United States
(12) Patent Application Publication
(10) Pub. No.: US 2005/0273337 A1
(43) Pub. Date: Dec. 8, 2005

(54) Apparatus and method for synthesized audible response to an utterance in speaker-independent voice recognition

(76) Inventors: Adoram Erell, Herzlia (IL); Ezer Melzer, Tel Aviv (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/857,848

(22) Filed: Jun. 2, 2004

(51) Int. Cl. G10L 15/00

(52) U.S. Cl. 704/260

(57) ABSTRACT

When a speaker-independent voice-recognition (SIVR) system recognizes a spoken utterance that matches a phonetic representation of a speech element belonging to a predefined vocabulary, it may play a synthesized speech fragment as a means for the user to verify that the utterance was correctly recognized. When a speech element in the vocabulary has more than one possible pronunciation, the system may select the one most closely matching the user's utterance, and play a synthesized speech fragment corresponding to that particular representation.

### BACKGROUND OF THE INVENTION

A speaker-independent voice-recognition (SIVR) system identifies the meaning of a spoken utterance by matching it against a predefined vocabulary. For example, in a speaker-independent, telephone-dialing application, the vocabulary may include a list of names. When a user vocalizes one of the names in the vocabulary, the system recognizes the name and initiates a call to the telephone number with which the name is associated. Commonly, SIVR systems work by comparing a spoken utterance against each of a set of phonetic representations automatically generated from the textual representations of the vocabulary entries.

In order to avoid the consequences of erroneous recognition, SIVR applications may employ the technique of vocal verification to notify the user which vocabulary entry has been identified, and enabling him or her to decide whether to proceed. Vocal verification may be achieved by synthesizing the speech fragment to be played by automatically generating it from the text of the identified vocabulary entry using a process known as text-to-speech (TTS).

SIVR and TTS processes are both based on methods for automatically converting strings of text characters into corresponding sequences of abstract speech building blocks, known as phonemes. However, these conversion methods, hereinafter referred to as letter-to-phoneme (LTP) methods, are complicated by the fact that in languages such as English, many letters and strings of letters can represent two or more different sounds. For example, the string “ie” is pronounced differently in each of the following words: friend, fiend and lied. It is possible to improve the chances of selecting the correct pronunciation by dedicating a relatively large amount of memory space to the storage of a comprehensive set of conversion rules. However, in embedded applications such as telephones, memory is at a premium. An economical method for implementing pronunciation prediction for SIVR relies on generating, by statistical rules, a crude phonetic description corresponding to multiple possible pronunciations of a given text string out of which only some may be correct, and then matching each of these representations against an utterance that is to be recognized. Referring again to the hereinabove example, if the user says “friend”, the recognition process might try to match this utterance with each of the four phonetic representations generated when the string “ie” is pronounced as in the words friend, fiend and lied.

However, this economical method does not work for TTS, which by its nature must generate a single pronunciation. The result is that TTS processes either include accurate pronunciation predictions that consume a large amount of memory, or crude pronunciation predictions that save memory but tend to generate misleading and even ridiculous pronunciations that are unlikely to meet users' expectations.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a schematic block-diagram illustration of an exemplary speaker-independent voice-recognition system according to an embodiment of the present invention;

FIG. 2 is a schematic block-diagram illustration of an exemplary mobile cellular telephone incorporating the voice-recognition system described in FIG. 1;

FIG. 3 is a schematic flowchart illustration of a method for adding a vocabulary entry to the voice-recognition system described in FIG. 1;

FIG. 4 is a schematic flowchart illustration of a method for responding to a vocal command using the voice-recognition system described in FIG. 1; and

FIG. 5 is an exemplary word graph showing the various paths corresponding to different phonetic representations of a speech element, as stored in the vocabulary of the speaker-independent voice-recognition system described in FIG. 1.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures and components have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

In the specification and claims, the term “plurality” means “two or more”.

Some embodiments of the present invention are directed to a speaker-independent voice-recognition (SIVR) system using a method that allows the user to operate functions of an application by issuing vocal commands belonging to a previously-defined list of speech elements, including natural-language words, phrases, personal and proprietary names, ad-hoc nicknames and the like.

A text string may represent each of the speech elements to be recognized, and some embodiments of the invention include a letter-to-phoneme (LTP) conversion process that converts each textual representation into one or more possible phonetic representations that may be stored in a predefined vocabulary.

When a user issues a vocal command, the system may compare his or her utterance against the phonetic representations in the vocabulary, and may select the closest match that may identify the specific speech element that he or she is understood to have uttered.

The system may provide the user with a vocal verification of an identified speech element by playing a synthesized audible speech fragment, and the user may then accept or reject the selection. The method used in embodiments described hereinafter is particularly directed to playing a speech fragment synthesized from the specific phonetic representation most closely matching the user's utterance. By allowing the LTP process to generate multiple alternative phonetic representations of a given text string, and to select the pronunciation most closely matching a user's utterance, this method may provide more correctly synthesized and better-sounding vocal verifications when implemented using a given processing power and memory capacity. A potential benefit of the method, in which the same LTP module is used in both the SIVR and text-to-speech (TTS) components of a complete system, may therefore also be a manufacturing cost reduction achieved by a reduction of the processing power and memory capacity needed for implementing a voice-recognition system of acceptable quality.

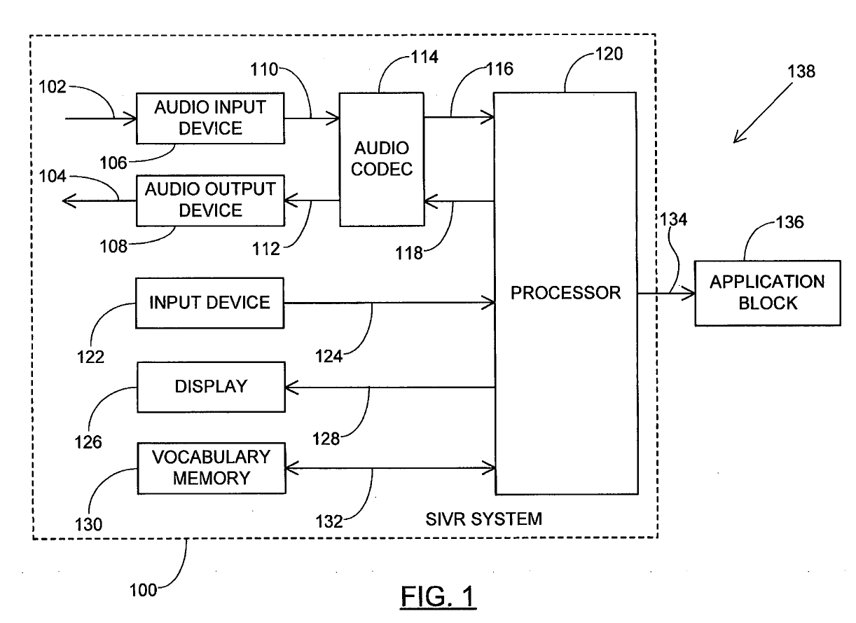

Reference is now made to FIG. 1, which illustrates an exemplary device in which an SIVR system controls an application block, in accordance with an embodiment of the present invention. The hereinafter discussion should be followed while bearing in mind that the described blocks of the voice-recognition system are limited to those relevant to some embodiments of this invention, and that the described blocks may have additional functions that are irrelevant to these embodiments.

A voice-controlled device 138 has an application block 136 that is controlled by an SIVR system 100. Examples of device 138 are a radiotelephone, a mobile cellular telephone, a landline telephone, a game console, a voice-controlled toy, a personal digital assistant (PDA), a hand-held computer, a notebook computer, a desktop personal computer, a workstation, a server computer, and the like. Examples of application block 136 are the transceiver of a mobile cellular telephone, a direct access arrangement (DAA) of a landline telephone, a motor and lamp control block of a voice-controlled toy, a desktop publishing program running on a personal computer, and the like. SIVR system 100 interprets a user's vocal commands and issues corresponding instructions to application block 136 by means of a command signal 134.

SIVR system 100 may include an audio input device 106, an audio output device 108, an audio codec 114, a processor 120, an input device 122, a display 126, and a vocabulary memory 130. It will be appreciated by those skilled in the art that SIVR system 100 may share some or all of the hereinabove constituent blocks with application block 136. For example, processor 120 may or may not perform processing functions of application block 136 in addition to its roles in implementing SIVR system 100, and vocabulary memory 130 may or may not share physical memory devices with storage memory used by application block 136.

Audio input device 106 may be a transducer, such as a microphone, for converting a received acoustic signal 102 into an incoming analog audio signal 110. Audio input device 106 may allow the user to issue vocal commands to the voice-recognition system.

Audio output device 108 may be a transducer, such as a loudspeaker, headset, or earpiece, for converting an outgoing analog audio signal 112 into a transmitted acoustic signal 104. Audio output device 108 may allow the voice-recognition system to play a speech fragment in response to a vocal command from the user, as a means of providing vocal verification of the speech element that it has recognized.

Audio codec 114 may convert incoming analog audio signal 110 into an incoming digitized audio signal 116 that it may deliver to processor 120, and may convert an outgoing digitized audio signal 118 generated by processor 120 into outgoing analog signal 112.

Input device 122 may be a keyboard, virtual keyboard, and the like, to allow the user to enter strings of alphanumeric characters, including the textual representations of vocal commands that the system may subsequently be called on to recognize; and to specify the actions to be associated with each of these text representations, such as entering a telephone number to be dialed when a specified vocal command is received. Input device 122 may indicate user selections to processor 120 using bus 124, which may be, for example, a universal serial bus (USB) interface, a personal computer keyboard interface, or an Electronic Industries Alliance (EIA) EIA232 serial interface.

Input device 122 may also include manual controls that allow the user to confirm or reject actions resulting from vocal commands, and to make requests and selections for the control of the system. These controls may be used, for example, to indicate that a vocal command is about to be issued, or to confirm or reject the vocal verification of a vocal command thereby causing the system to proceed with or to abandon the corresponding action. The manual controls may optionally be separate manual controls, such as pushbuttons mounted on the steering wheel of an automobile, that may replace or duplicate manual controls included in input device 122.

Display 126, which may be a cellular telephone liquid crystal display (LCD), personal computer visual display unit, PDA display, and the like, may visually indicate to the user which characters he or she has entered using input device 122, and may provide other indications as required, such as prompting the user to complete a procedure and providing a visual indication of a recognized vocal command. It will be readily appreciated by those skilled in the art that display 126 may be combined with a pointing device such as a light pen, finger-operated or stylus-operated touch panel, game joystick, computer mouse, softkeys, set of selection and cursor movement keys, and the like, or combinations thereof, to additionally perform the functions of a virtual keyboard that may replace some or all of the functions of input device 122. Processor 120 may send signals to display 126 using display bus 128. Examples of display bus 128 are a Video Graphics Array (VGA) bus driving a computer visual display unit, and an LCD interface for driving a proprietary LCD display module.

Vocabulary memory 130 may store at least one phonetic representation and a description of an action to be performed for each of the speech elements that the system is to recognize, and the textual representation associated with each of these speech elements. It may also store acoustic models associated with the phoneme set used, such as hidden Markov models, dynamic time-warping templates, and the like, which are either fixed or undergo adaptation to the users' speech while the application is being deployed. Vocabulary memory 130 may be, for example, a compact flash (CF) memory card; a Personal Computer and Memory Card International Association (PCMCIA) memory card; a MEMORY® card; a USB KEY® memory card; an electrically-erasable, programmable, read-only memory (EEPROM); a non-volatile, random-access memory (NVRAM); a synchronous, dynamic, random-access memory (SDRAM); static, random-access memory (SRAM); a memory integrated into a microprocessor or microcontroller; a compact-disk, read-only memory (CD-ROM); a hard disk; a floppy disk; and the like.

Processor 120 may write data to and retrieve data from vocabulary memory 130 using memory bus 132, which may be a USB, a flash memory device interface, a Personal Computer and Memory Card International Association (PCMCIA) card bus, and the like.

Processor 120 may be, for example, a personal computer central processing unit (CPU), a notebook computer CPU, a PDA CPU, a digital signal processor (DSP), a reduced instruction set computer (RISC), a complex instruction set computer (CISC), or an embedded microcontroller or microprocessor.

Processor 120 may communicate with controlled application 136 by means of command signal 134, which may, for example, be transported over a physical medium such as a USB, an EIA232 interface, a shared computer bus, a microprocessor parallel port, a microprocessor serial port, or a dual-port, random-access memory (RAM) interface. When resources of processor 120 are shared between SIVR system 100 and application block 136, command signal 134 may constitute, for example, a set of command bytes that software routines of SIVR system 100 pass on to software routines belonging to controlled application 136.

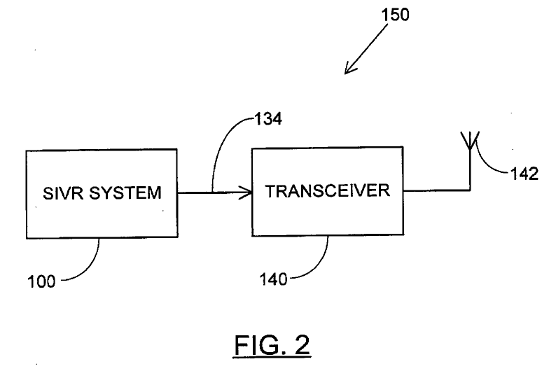

Reference is now additionally made to FIG. 2, in which an exemplary voice-controlled, mobile cellular telephone, in accordance with a further embodiment of the present invention, is illustrated.

A voice-controlled, mobile cellular telephone 150 may include SIVR system 100, a transceiver 140, and an antenna 142. SIVR system 100 may control functions of the cellular telephone by means of command signal 134. Other blocks of cellular telephone 150 are omitted from FIG. 2 because they are not concerned with the voice-operating functions of the described embodiments. However, it will be appreciated by those skilled in the art that SIVR system 100 may share some or all of its constituent blocks with cellular telephone functions that are not associated with the voice-recognition function. For example, audio input device 106 may serve not only as the means by which SIVR system 100 may receive vocal commands from the user, but also for receiving the speech to be transmitted to a distant party with whom the user is communicating; and processor 120 may additionally perform functions associated with aspects of cellular telephone operation that are unrelated to SIVR.

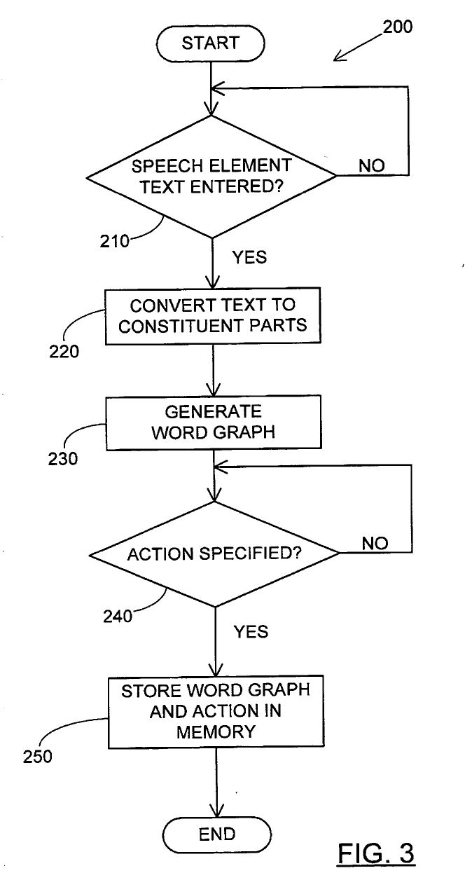

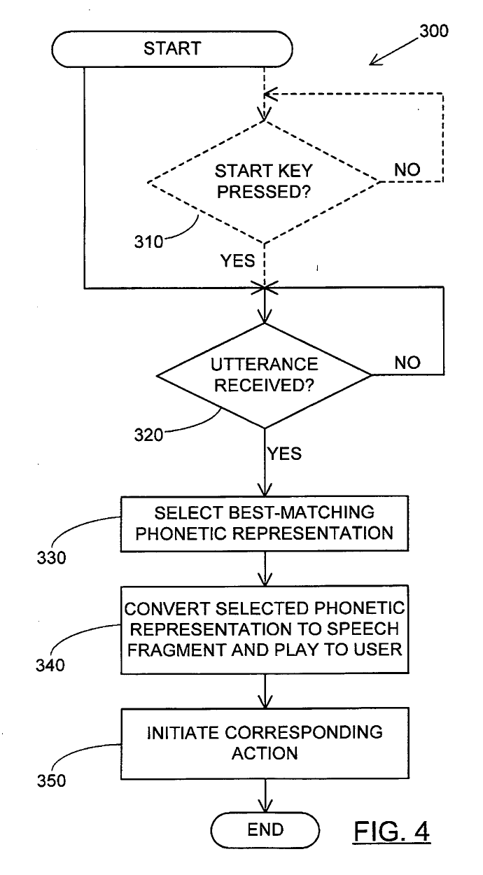

The operation of controller 120 in conjunction with the other system blocks is better understood if reference is made additionally to FIGS. 3 and 4, in which schematic flowchart illustrations describe methods for adding a vocabulary entry and for responding to a vocal command, respectively, according to an embodiment of the present invention.

The purpose of process 200, which is illustrated in FIG. 3, is to add to the vocabulary one or more phonetic representations corresponding to a new speech element. Upon START, process 200 may advance to block 210 in which it waits for the user to define a new speech element to be recognized by the system. By means of input device 122, the user may define a new speech element by entering the element's textual representation in its natural-language spelling, and may then press an ENTER key, or perform some similar operation, to indicate when text entry is complete. For example, the user may enter the text “Stephen” to indicate the name of a party to be subsequently dialed when the vocal command “Stephen” is uttered.

Process 200 may advance to block 220 when the user has completed entry of the text string representing the new speech element. In block 220, processor 120 may convert the speech element text into constituent parts corresponding to identifiable phonemes or groups of phonemes. For the hereinabove example, processor 120 may divide the text “Stephen” into “s”, “t”, “e”, “ph” and “en”. It will be clearly apparent to those skilled in the art that the subdivision shown for this example is selected only for the purpose of conveniently illustrating the method and represents only one of a number of alternative ways of dividing the text “Stephen” into its constituent phonemes and phoneme groups, and moreover that subdividing the text into groups of letters is only one of several ways to start the LTP process. On completion of block 220, process 200 may advance to block 230.

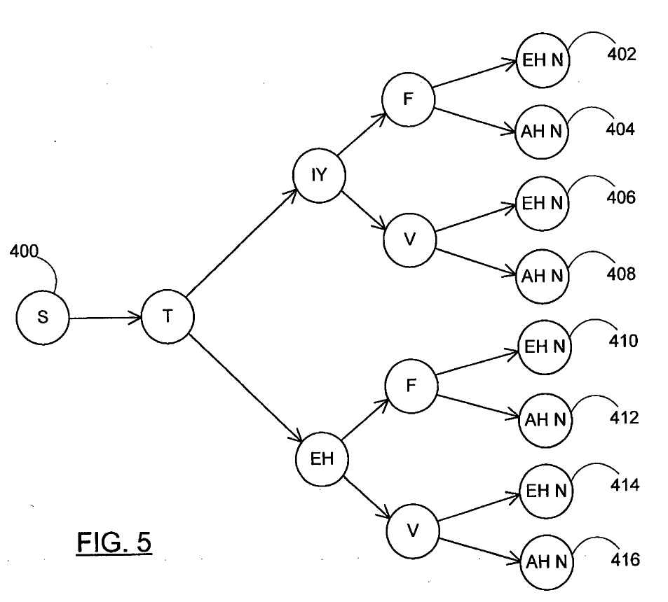

In block 230, processor 120 may convert the textual representation entered by the user into possible phonetic representations by first converting the aforementioned constituent parts into possible phonetic representations, and then concatenating the representations in the form of a word graph. Continuing the aforementioned example, and using the phoneme set of the Pronouncing Dictionary, version 0.6, developed by Carnegie Mellon University (CMU), which is a machine-readable pronouncing dictionary for North American English that is available on CMU's Internet website, the rules for converting the constituent parts into possible phonetic representations might state that “e” may be pronounced “EH” as in “Devon” or “IY” as in “demon”, that “ph” may be pronounced “F” or “V”, and that “en” may be pronounced “EH N” as in “encode” or “AH N+ as in “seven”. Reference is now made to FIG. 5, which illustrates an exemplary word graph that may correspond to the name Stephen, in which are shown eight paths, beginning at starting node 400 and ending at nodes 402 to 416. It will be apparent to those skilled in the art that the word graph may be stored in vocabulary memory 130 in a way that is more compact than that represented in FIG. 5, that multiple nodes may be replaced by single nodes and that multiple edges may enter each node. For instance, there may be one node for each of “F”, “V”, “EH”, “AH” and “N”. The two paths beginning at node 400 and ending at nodes 408 and 412 belong to the phonetic representations of the two normal pronunciations of the name Stephen, while other paths belong to pronunciations that are generally considered to be invalid. This is just one example of a case in which a speech element has more than one accepted pronunciation, and in general, multiple alternative pronunciations may be acceptable according to individual preference, regional accent, and the like. On completion of block 230, process 200 may advance to block 240.

In block 240, process 200 may wait for the user to specify, by means of input device 122, the action to be performed when the system subsequently recognizes a vocal command corresponding to the entered text. The process of specifying the required action may, for example, be by simple text entry, by menu-driven entry, in which the user selects possible actions from a list shown on display 126, or a combination of both. In the case of the hereinabove example, the user might indicate that the entered text “Stephen” refers to a command to dial Stephen's number, by first choosing “Dial” from a list of displayed actions, and then entering Stephen's telephone number. Block 240 may alternatively precede block 210 in the flow of process 200. Process 200 may advance to block 250 when the user finishes specifying the required action.

In block 250, processor 120 may store in vocabulary memory 130 the word graph containing the speech element's phonetic representations, together with a description or indication of the corresponding action to be taken when this speech element is recognized. The word graph may be stored in vocabulary memory 130 in a manner in which it is linked together with the word graphs generated for previously added speech elements, to create a single word graph encompassing all phonetic representations of all of the speech elements. Optionally, the description or indication of an action may be stored elsewhere, especially where all of the speech elements may be associated with a single type of action, and may differ only in a specific detail. For example, in implementing a cellular telephone that uses voice control for the purposes of dialing numbers, it might be advantageous to omit the description or indication of the dialing action from vocabulary memory 130, and to store only the number to be dialed when each of the speech elements is recognized. As a further option, processor 120 may also store in vocabulary memory 130 the text representation itself, as for example, in an SIVR system that is required to show the text on display 126 in response to a vocal command, or when allowing the user to search a list of vocabulary entries for a particular entry that he or she wishes to modify or delete. Process 200 may end on completion of block 250.

The purpose of process 300, which is described in FIG. 4, is to recognize and act on a vocal command. Upon START, process 300 may advance to block 320. Optionally, upon START, process 300 may advance to block 310 where it may wait for the user to press a START or similar key of input device 122, or activate a separate manual control, to indicate that he or she is about to issue a vocal command. Process 300 may then advance to block 320.

The user may then issue a vocal command by uttering one of the speech elements previously defined using process 200 or otherwise, such that the vocal command may be received by audio input device 106 and converted into incoming analog signal 110. Audio codec 114 may convert incoming analog signal 110 corresponding to the utterance into incoming digitized signal representation 116, which may be delivered to processor 120. In block 320, processor 120 may examine incoming digitized audio signal 116, and when it detects that an utterance has been received, process 300 may advance to block 330.

In block 330, processor 120 may search the word graph stored in vocabulary memory 130 for the phonetic representation most closely matching the received utterance. When a speech element has more than one accepted pronunciation, different users may articulate it in different ways, or the same user may articulate it in different ways on different occasions, possibly resulting in processor 120 selecting different paths of the word graph depending on the pronunciation of the vocal command. In the aforementioned example, the normal pronunciations of the name Stephen correspond to the paths S-T-IY-V-AH-N and S-T-EH-F-AH-N, starting at node 400 and ending at nodes 408 and 412, respectively, in the exemplary word graph described in FIG. 5. If the user pronounces the name Stephen as S-T-IY-V-AH-N, processor 120 may select the path starting at node 400 and ending at node 408 as the one belonging to the phonetic representation most closely matching the received utterance. If, on the other hand, the user pronounces the name Stephen as S-T-EH-F-AH-N, processor 120 may select the path starting at node 400 and ending at node 412. For the sake of completeness, it is added that in case no close match can be found, the process may optionally request the user to repeat the command. In the interests of clarity, this optional step is omitted from the flowchart illustration in FIG. 4. On completion of block 330, process 300 may advance to block 340.

In block 340, processor 120 may convert the phonetic representation described in the selected path into a speech fragment and may play it to the user by delivering it over outgoing digitized voice signal 118, which audio codec 114 may convert into analog signal 112 and send to audio output device 108. Optionally, processor 120 may also show on display 126 the textual representation corresponding to the recognized speech element, which is the text that the user previously entered during execution of process 200, block 210, and which may have been stored in vocabulary memory 130. Additionally, or instead of displaying the textual representation, processor 120 may display other information associated with that text. On completion of block 340, the process may advance to block 350.

In block 350, processor 120 may retrieve from vocabulary memory 130 the description of the predetermined action corresponding to the recognized speech element, and may initiate the action by delivering the corresponding command to application block 136 by means of control signal 134. In the hereinabove example, which is particularly applicable to the case in which application block 136 is transceiver 140 of mobile cellular telephone 150, processor 120 may command transceiver 140 to establish a connection with a specified distant party. In this particular example, the command is to dial the number that had previously been associated with the name Stephen when process 200 added this name to vocabulary memory 130. Optionally, before sending the command to application block 136, processor 120 may first wait for the user to confirm the selection and initiate the action by pressing a CONFIRM or similar key of input device 122. An alternative optional step might be for processor 120 to wait for a predetermined period, which may be, for example, around two to five seconds, during which the user will be given the opportunity to reject the selection and cancel the action by pressing a CANCEL or similar key of input device 122, or activate a separate manual control. For the sake of simplicity, these optional steps are omitted from the flowchart description of FIG. 4. Process 300 may end on completion of block 350.

In another embodiment of the system, the processes of converting textual representations of speech elements into phonetic representations and determining the action to be performed upon recognition of each speech element may be exclusively or additionally performed using a separate apparatus, and may or may not be omitted from the SIVR system. Omitting these processes from the SIVR system may in turn remove the need for an input device for text entry and a display, and may also decrease the required system memory capacity, and hence may reduce the system's cost, size and complexity. One example of such a system is a speaker-independent, voice-controlled toy.

In this embodiment, the phonetic representations of the speech elements and the actions to be associated with the speech elements generated by the separate apparatus may be preloaded into the SIVR system's vocabulary memory before or during the manufacture of the system, or may be loaded into the SIVR system's vocabulary memory after the system has been manufactured, or even after it has been deployed. For instance, a speaker-independent, voice-operated, mobile cellular telephone might download phonetic representations to its vocabulary memory from a server belonging to the cellular telephone provider, from the Internet, from another cellular telephone, or from a computer to which it is connected by a cable or wireless link.

In a variation of this embodiment, the textual representations of the speech elements and the action to be performed upon recognition of each speech element may be loaded into the system from a separate apparatus, and may or may not be omitted from the SIVR system. For example, a voice-operated, mobile cellular telephone or a combination PDA and cellular telephone might download from a computer to which it is connected by a cable or wireless link a list of contact names and telephone numbers to be dialed.

In another embodiment of the invention, only the textual representations of speech elements may be stored in the vocabulary memory, and when it is called upon to recognize a vocal command the SIVR system may convert, on-the-fly, the text strings into phonetic representations.

In a further embodiment of the invention, speech elements may be concatenated to generate a single vocal command. For example, the user may utter the speech element “delete”, to which the SIVR system may provide vocal verification, following which the user may utter the name “Stephen”, to which the system may provide vocal verification and may then delete the vocabulary entries associated with the name “Stephen”.

Instructions to enable processor 120 to perform methods of embodiments of the present invention may be stored in a memory (not shown) of device 138 or on a computer-readable storage medium, such as a floppy disk, a CD-ROM, a personal computer hard disk, a CF memory card; a PCMCIA memory card, a server hard disk, an FTP server hard disk, an Internet server hard disk accessible from an Internet web page, and the like.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

1. A method comprising:
selecting one of a plurality of phonetic representations of speech elements of a predefined vocabulary that most closely matches an utterance, wherein said plurality of phonetic representations includes multiple phonetic representations of any of said speech elements having different possible pronunciations; and
synthesizing an audible speech fragment according to said one of said phonetic representations.

2. The method of claim 1, further comprising:
storing said phonetic representations.

3. The method of claim 1, further comprising:
generating said phonetic representations from textual representations of said speech elements.

4. The method of claim 1, further comprising:
displaying information identifying the speech element represented by said one of said phonetic representations that most closely matches said utterance.

5. The method of claim 1, further comprising:
performing a predetermined action associated with one of said speech elements.

6. The method of claim 2, wherein storing said phonetic representations further comprises storing said phonetic representations as a word graph.

7. An apparatus comprising:
a processor to select one of a plurality of phonetic representations of speech elements of a predefined vocabulary that most closely matches a portion of an incoming digitized voice signal corresponding to an utterance, wherein said plurality of phonetic representations includes multiple phonetic representations of any of said speech elements having different possible pronunciations, and to synthesize an outgoing digitized voice signal according to said one of said phonetic representations.

8. The apparatus of claim 7, further comprising:
a memory to store said phonetic representations.

9. The apparatus of claim 8, wherein said memory is to store said phonetic representations as a word graph.

10. The apparatus of claim 7, wherein said processor is to generate said phonetic representations from textual representations of said speech elements.

11. The apparatus of claim 10, further comprising:
an input device to allow entry of said textual representations.

12. The apparatus of claim 7, further comprising:
a display,
wherein said processor is to show on said display information identifying the speech element represented by said one of said phonetic representations that most closely matches said utterance.

13. The apparatus of claim 7, wherein said processor is to initiate a predetermined action associated with one of said speech elements.

14. A voice-operated, mobile cellular telephone comprising:
a transceiver;
an antenna; and
a processor to select one of a plurality of phonetic representations of speech elements of a predefined vocabulary that most closely matches a portion of an incoming digitized voice signal corresponding to an utterance, wherein said plurality of phonetic representations includes multiple phonetic representations of any of said speech elements having different possible pronunciations, and to synthesize an outgoing digitized voice signal according to said one of said phonetic representations.

15. The voice-operated, mobile cellular telephone of claim 14, further including:
a memory to store said phonetic representations.

16. The voice-operated, mobile cellular telephone of claim 15, wherein said memory is to store said phonetic representations as a word graph.

17. The voice-operated, mobile cellular telephone of claim 14, wherein said processor is to generate said phonetic representations from textual representations of said speech elements.

18. The voice-operated, mobile cellular telephone of claim 17, further including:
an input device to allow entry of said textual representations.

19. The voice-operated, mobile cellular telephone of claim 14, wherein said processor is to initiate a predetermined action associated with one of said speech elements.

20. The voice-operated, mobile cellular telephone of claim 19, wherein said predetermined action further includes commanding said transceiver to establish a connection with a specified distant party.

21. An article comprising a computer-readable storage medium having stored thereon instructions that, when executed by a processor, result in:
selecting one of a plurality of phonetic representations of speech elements of a predefined vocabulary that most closely matches an utterance, wherein said plurality of phonetic representations includes multiple phonetic representations of any of said speech elements having different possible pronunciations; and
synthesizing an audible speech fragment according to said one of said phonetic representations.

22. The article of claim 21, wherein said instructions further result in:
storing said phonetic representations.

23. The article of claim 21, wherein said instructions further result in:
storing said phonetic representations as a word graph.

24. The article of claim 21, wherein said instructions further result in:
generating said phonetic representations from textual representations of said speech elements.
